(19) United States
(12) Patent Application Publication
(10) Pub. No.: US 2016/0211737 A1
(43) Pub. Date: Jul. 21, 2016

(54) Active Filter and Communications System

(71) Applicant: Huawei Technologies Co., Ltd., Shenzhen (CN)

(72) Inventors: Dan Yang, Shenzhen (CN); Qinghai Wang, Shenzhen (CN); Yongfa Zhu, Shenzhen (CN)

(21) Appl. No.: 15/083,853

(22) Filed: Mar. 29, 2016

Related U.S. Application Data
(63) Continuation of application No. PCT/CN2015/086525, filed on Aug. 10, 2015.

(30) Foreign Application Priority Data
Jan. 4, 2015 (CN) 201510003854.X

(51) Int. Cl. H02M 1/12; H02M 1/44; H02M 3/158

(52) U.S. Cl. CPC H02M 1/12; H02M 3/158; H02M 1/44

(57) ABSTRACT

An active filter, which may effectively suppress the low-frequency noise, includes a main circuit and a control circuit. The control circuit is configured to detect a first current output by a negative electrode of an input end of a conversion circuit to acquire an alternating current component (harmonic component) in the first current, and generate a control signal according to the harmonic component. The main circuit is configured to generate, under the control of the control signal, a second current having a phase opposite to a phase of the harmonic component, so that a source current formed after the first current and the second current pass through a power source is a direct current.

### CROSS-REFERENCE TO RELATED APPLICATIONS

This application is a continuation of International Application No. PCT/CN2015/086525, filed on Aug. 10, 2015, which claims priority to Chinese Patent Application No. 201510003854.X, filed on Jan. 4, 2015, both of which are hereby incorporated by reference in their entireties.

### TECHNICAL FIELD

Embodiments of the present disclosure relate to communications technologies, and in particular, to an active filter and a communications system.

### BACKGROUND

As shown in FIG. 1, an existing communications system generally includes a conversion circuit 2, a load 3, and a power source 4. The power source 4 generally provides a 48 volts (V) input voltage, and in an actual application, the input voltage may fluctuate between 36V and 60V. The conversion circuit 2 is generally a direct current/direct current (DC/DC) conversion circuit. Another conversion circuit (not shown) converts the alternating current (AC) power source 4 to DC. After converting a current provided by the power source 4, the conversion circuit 2 provides a converted current to the load 3, and supplies power to the load 3. The load 3 may be various communications devices in an actual communications system, and is not limited herein. However, because currents of some communications devices change greatly in different working scenarios, the load 3 is represented as a non-linear load that changes periodically, and further, a low-frequency fluctuation of the current input by the conversion circuit is caused. However, the current fluctuation may induce a voltage on spurious impedance of a power bus, that is, low-frequency noise. Because the power bus is also connected to another communications device, the low-frequency noise may spread to another communications device, and interfere with normal working of the other communications devices. Therefore, in the communications system, it is necessary to eliminate the low-frequency noise caused by non-linearity of the load 3. In FIG. 1, IL represents a current output by the negative electrode of the input end of the conversion circuit 2 and returned to the power source 4.

To solve the foregoing problem, a passive low-frequency filter solution is used in the prior art, that is, a low-pass filter is disposed in the communications system to implement filtering of the low-frequency noise. The low-pass filter is not shown herein. Reference may be made to the prior art. The low-pass filter is generally a filter circuit including an inductor, a capacitor, and/or a resistor.

Considering a loss, when the passive filter is used, because the inductor and the resistor are connected in series in the power bus, values of the inductor and the resistor cannot be too great. Consequently, a very large capacitor capacity is required, and a volume of the low-pass filter is huge, which cannot meet a requirement for miniaturization of the communications system.

### SUMMARY

Embodiments of the present disclosure provide an active filter and a communications system to effectively suppress low-frequency noise and meet a requirement for miniaturization of a communications system.

According to a first aspect, an embodiment of the present disclosure provides an active filter, where the active filter is connected in parallel between a power source and an input end of a conversion circuit, where an input end of the active filter is separately coupled to a positive electrode of the power source and a positive electrode of the input end of the conversion circuit, an output end of the active filter is separately coupled to a negative electrode of the power source and a negative electrode of the input end of the conversion circuit, and the active filter includes a main circuit and a control circuit, where: the control circuit is configured to detect a first current output by the negative electrode of the input end of the conversion circuit to acquire an alternating current component (a harmonic component) in the first current, and generate a control signal according to the harmonic component. The main circuit is configured to generate, under control of the control signal, a second current having a phase opposite to a phase of the harmonic component, so that a source current formed after the first current and the second current pass through the power source is a direct current.

In a first possible implementation manner of the first aspect, the control signal includes a first control signal and a second control signal, where the second control signal is a signal having a phase opposite to a phase of the first control signal. The main circuit includes a full-bridge circuit, an inductor, and a capacitor, where the full-bridge circuit includes a first switching transistor, a second switching transistor, a third switching transistor, and a fourth switching transistor, where a series circuit including the first switching transistor and the fourth switching transistor is separately connected in parallel with the capacitor and a series circuit including the second switching transistor and the third switching transistor. One end of the inductor is coupled to a node between the first switching transistor and the fourth switching transistor, the other end of the inductor is used as the input end of the active filter, a node between the second switching transistor and the third switching transistor is used as the output end of the active filter, control ends of the first switching transistor and the third switching transistor separately receive the first control signal, and control ends of the second switching transistor and the fourth switching transistor separately receive the second control signal. The main circuit is configured to perform, under control of the control signal, conductivity switching on the full-bridge circuit, and thereby control charging or discharging of the inductor and charging or discharging of the capacitor to generate the second current.

In a second possible implementation manner of the first aspect, the control signal includes a first control signal and a second control signal, where the second control signal is a signal having a phase opposite to a phase of the first control signal. The main circuit includes an inductor, a capacitor, a fifth switching transistor, and a sixth switching transistor, where the sixth switching transistor is connected in parallel with a series circuit including the capacitor and the fifth switching transistor, one end of the sixth switching transistor is coupled to one end of the inductor, another end of the sixth switching transistor is used as the output end of the active filter, the other end of the inductor is used as the input end of the active filter, a control end of the fifth switching transistor receives the first control signal, and a control end of the sixth switching transistor receives the second control signal. The main circuit is configured to perform, under control of the control signal, conductivity switching on the fifth switching transistor and the sixth switching transistor, and thereby control charging or discharging of the inductor and charging or discharging of the capacitor to generate the second current.

With reference to the first possible implementation manner of the first aspect or the second possible implementation manner of the first aspect, in a third possible implementation manner of the first aspect, the control circuit includes a high-pass filter, an adder, a first proportional-integral controller, a second proportional-integral controller, a voltage comparator, and a phase inverter, where the high-pass filter is configured to receive the first current, and perform filtering to obtain the harmonic component. The adder is configured to separately receive the harmonic component and the second current, and perform addition to obtain a third current. The first proportional-integral controller is configured to separately receive a preset first reference voltage and an output voltage that is of the main circuit, and after subtracting the output voltage from the first reference voltage, perform first proportional integration to obtain a fourth current, where the output voltage of the main circuit is a voltage between two ends of the capacitor. The second proportional-integral controller is configured to: separately receive the third current and the fourth current, and after subtracting the third current from the fourth current, perform second proportional integration to obtain a first comparative voltage. The voltage comparator is configured to compare the first comparative voltage with a preset second reference voltage, and generate the first control signal according to a comparison result. The phase inverter is configured to invert the phase of the first control signal to obtain the second control signal.

With reference to the third possible implementation manner of the first aspect, in a fourth possible implementation manner of the first aspect, the second reference voltage is a periodic triangular wave signal, and therefore, in any period, the voltage comparator is further configured to generate the first control signal for turning off the first switching transistor and the third switching transistor or turning off the fifth switching transistor if the first comparative voltage is higher than a level of the triangular wave signal or generate the first control signal for turning on the first switching transistor and the third switching transistor or turning on the fifth switching transistor if the first comparative voltage is lower than a level of the triangular wave signal.

With reference to the first possible implementation manner of the first aspect or the second possible implementation manner of the first aspect, in a fifth possible implementation manner of the first aspect, the control circuit includes a high-pass filter, an adder, a first proportional-integral controller, a hysteresis comparator, and a phase inverter, where the high-pass filter is configured to receive the first current, and perform filtering to obtain the harmonic component. The adder is configured to separately receive the harmonic component and the second current, and perform addition to obtain a third current. The first proportional-integral controller is configured to separately receive a first reference voltage and an output voltage that is of the main circuit, and after subtracting the output voltage from the first reference voltage, perform first proportional integration to obtain a fourth current, where the output voltage of the main circuit is a voltage between two ends of the capacitor. The hysteresis comparator is configured to compare the third current with the fourth current, and generate the first control signal according to a comparison result. The phase inverter is configured to invert the phase of the first control signal to obtain the second control signal.

With reference to the fifth possible implementation manner of the first aspect, in a sixth possible implementation manner of the first aspect, the hysteresis comparator is further configured to generate the first control signal for turning on the first switching transistor and the third switching transistor or turning on the fifth switching transistor if the third current is greater than the fourth current, or if the third current is less than the fourth current, generate the first control signal for turning off the first switching transistor and the third switching transistor or turning off the fifth switching transistor.

With reference to any implementation manner in the first possible implementation manner of the first aspect to the sixth possible implementation manner of the first aspect, in a seventh possible implementation manner of the first aspect, the inductor is a filter inductor, and the capacitor is an energy storage capacitor or a group of energy storage capacitors.

According to a second aspect, the present disclosure provides a communications system, where the communications system includes a power source, a conversion circuit, a non-linear load, and the active filter provided in the first aspect of the present disclosure and any implementation manner in the first possible implementation manner of the first aspect to the seventh possible implementation manner of the first aspect, where the power source is configured to output the source current, and the conversion circuit is configured to receive the source current through an input end, and after performing direct current/direct current conversion, output a converted current to the non-linear load through an output end, to supply power to the non-linear load.

In a first possible implementation manner of the second aspect, the communications system further includes an electromagnetic interference filter, where the electromagnetic interference filter is connected in parallel between the power source and the active filter, and configured to suppress high-frequency interference in the communications system.

By using the active filter and the communications system in the embodiments of the present disclosure, because the active filter is used to perform filtering, introduction of a passive filter and a large capacitor is avoided. The active filter has a small volume, and can effectively suppress low-frequency noise caused by a non-linear load and meet a requirement for miniaturization of the communications system.

### BRIEF DESCRIPTION OF DRAWINGS

To describe the technical solutions in the embodiments of the present disclosure more clearly, the following briefly introduces the accompanying drawings required for describing the embodiments or the prior art. Apparently, the accompanying drawings in the following description show some embodiments of the present disclosure, and persons of ordinary skill in the art may still derive other drawings from these accompanying drawings without creative efforts.

FIG. 1 is a schematic structural diagram of an existing communications system;

FIG. 2 is a schematic structural diagram of a communications system using an active filter according to an embodiment of the present disclosure;

FIG. 3 is a schematic diagram of a main circuit of an active filter according to an embodiment of the present disclosure;

FIG. 4 is a schematic diagram of a main circuit of another active filter according to an embodiment of the present disclosure;

FIG. 5 is a schematic diagram of a control circuit of an active filter according to an embodiment of the present disclosure;

FIG. 6 is a logical diagram of a time sequence of a first control signal generated by the control circuit shown in FIG. 5;

FIG. 7 is a schematic diagram of a control circuit of another active filter according to an embodiment of the present disclosure;

FIG. 8 is a logical diagram of a time sequence of a first control signal generated by the control circuit shown in FIG. 7; and

FIG. 9 is a schematic structural diagram of another communications system using an active filter according to an embodiment of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by persons of ordinary skill in the art based on the embodiments of the present disclosure without creative efforts shall fall within the protection scope of the present disclosure.

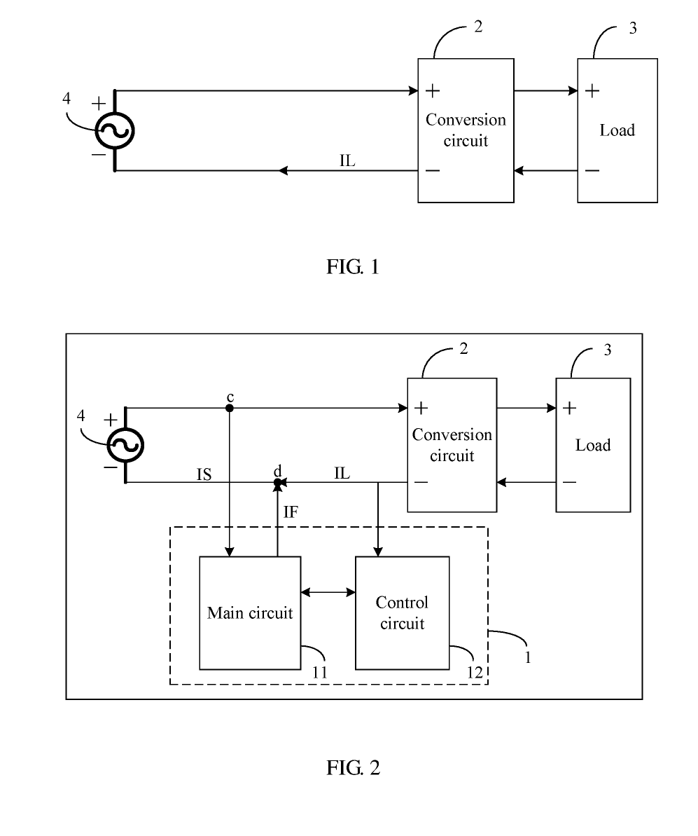

As shown in FIG. 2, an embodiment of the present disclosure provides a communications system, including an active filter 1, a conversion circuit 2, a load 3, and a power source 4, where, an input end of the active filter 1 is separately coupled to a positive electrode of the power source 4 and a positive electrode of an input end of the conversion circuit 2. An output end of the active filter 1 is separately coupled to a negative electrode of the power source 4 and a negative electrode of the input end of the conversion circuit 2, a positive electrode of an output end of the conversion circuit 2 is coupled to a positive electrode of the load 3, and a negative electrode of the output end of the conversion circuit 2 is coupled to a negative electrode of the load 3, thereby forming a conductive loop. The power source 4 is configured to output a source current while the conversion circuit 2 is configured to receive the source current through the input end, and after performing DC/DC conversion, output a converted current to the load 3 through the output end, to supply power to the load 3.

The active filter 1 includes a main circuit 11 and a control circuit 12.

In this embodiment, the source current output by the power source 4 may be marked with IS. The output end of the conversion circuit 2 is coupled to the non-linear load 3. After a low-frequency fluctuation of the current input by the conversion circuit 2 to the load 3 is caused by non-linearity of the load 3, a first current output by the negative electrode of the input end of the conversion circuit and returned to the power source 4 includes a direct current component and a harmonic component. Herein, the first current is marked with IL, the direct current component of the first current IL is defined with IL_{DC}, and the harmonic component of the first current IL is defined with IL_{AC}. In addition, a second current output by the active filter 1 is marked with IF.

A relationship between the source current IS, the first current IL, and the second current IF is shown in a formula (1):

IS=IF+IL (1)

In addition, the first current IL includes the direct current component IL_{Dc} and the harmonic component IL_{AC}, as shown in a formula (2):

IL=IL_{DC}+IL_{AC} (2)

By substituting the formula (2) into the formula (1), a formula (3) may be obtained:

IS=IF+IL_{DC}+IL_{AC} (3)

It can be known that, in an ideal case, to suppress low-frequency noise, that is, to eliminate the current fluctuation caused by the non-linear load 3, so that the source current IS output by the power source 4 is approximate to the direct current, that is, IS=IL_{DC}, the active filter 1 needs to output the second current IF having a phase opposite to a phase of the harmonic component IL_{AC} to cancel the harmonic component IL_{AC}. That is, the second current IF meets a formula (4):

IF+IL_{AC}=0 (4)

The following describes in detail how to suppress low-frequency noise with reference to the main circuit 11 and the control circuit 12 of the active filter 1 in this embodiment.

In this embodiment, the control circuit 12 may be configured to detect the first current IL output by the negative electrode of the input end of the conversion circuit 2 to acquire the harmonic component IL_{AC} in the first current, and generate a control signal according to the harmonic component IL_{AC}. The main circuit 11 is configured to generate, under control of the control signal, the second current IF having the phase opposite to the phase of the harmonic component IL_{AC}, so that the source current IS formed after the first current IL and the second current IF pass through the power source is a direct current.

In the communications system in this embodiment, because an active filter 1 is used to generate a second current IF having a phase opposite to a phase of a harmonic component IL_{AC}, a current fluctuation caused by non-linearity of a load 3 is canceled, low-frequency noise in the communications system is suppressed, and interference to another communications device in the communications system is avoided.

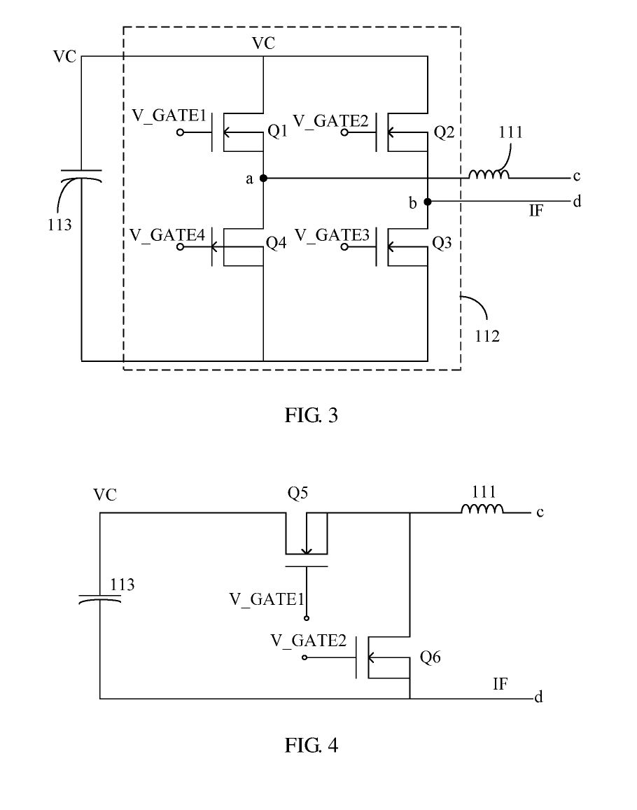

In an implementation manner of this embodiment, a specific structure of the main circuit 11 may be shown in FIG. 3. In FIG. 3, the main circuit 11 may include: an inductor 111, a full-bridge circuit 112, and a capacitor 113, where the full-bridge circuit 112 may include a first switching transistor Q1, a second switching transistor Q2, a third switching transistor Q3, and a fourth switching transistor Q4. It should be noted that a person skilled in the art should know that, the switching transistors in the full-bridge circuit 112 in this embodiment of the present disclosure may be various switching transistors including control ends in the prior art, such as a metal oxide semiconductor (MOS) transistor, a transistor, a field effect transistor (FET). The inductor 111 may be a filter inductor, and the capacitor 113 may include an energy storage capacitor or a group of energy storage capacitors. For details about requirements of the full-bridge circuit on the filter inductor and the energy storage capacitor, reference may be made to the prior art. In addition, the control signal generated by the control circuit 12 may further include a first control signal and a second control signal, where the second control signal is a signal having a phase opposite to a phase of the first control signal. In FIG. 3, an N-type MOS (NMOS) transistor is used to exemplarily describe each switching transistor in the main circuit 11, where each NMOS transistor may receive a control signal through a gate (that is, a control end) to control conductivity between a source and a drain of the NMOS transistor. In FIG. 3, V_GATE1, V_GATE2, V_GATE3, and V_GATE4 are respectively used to mark a control signal of a gate of each NMOS transistor, where V_GATE1 and V_GATE3 are the first control signal, and V_GATE2 and V_GATE4 are the second control signal. When the control signal is of a high level, the NMOS transistor is turned on and when the control signal is of a low level, the NMOS transistor is turned off. Working principles of another switching transistor such as a P-type MOS (PMOS) transistor is similar to working principles of the NMOS transistor, and are not further described herein. For details, reference may be made to the prior art.

Furthermore, in the full-bridge circuit 112, a series circuit including the first switching transistor Q1 and the fourth switching transistor Q4 is separately connected in parallel with the capacitor 113 and a series circuit including the second switching transistor Q2 and the third switching transistor Q3. One end of the inductor 111 is coupled to a node “a” between the first switching transistor Q1 and the fourth switching transistor Q4, and the other end of the inductor 111 is used as the input end of the active filter 1 and is separately coupled to the positive electrode of the power source 4 and the positive electrode of the input end of the conversion circuit 2, that is, as shown in FIG. 2, jointly coupled to a node “c”. A node “b” between the second switching transistor Q2 and the third switching transistor Q3 is used as the output end of the active filter 1, and is separately coupled to the negative electrode of the power source 4 and the negative electrode of the input end of the conversion circuit 2, that is, as shown in FIG. 2, jointly coupled to a node “d”. Control ends of the first switching transistor Q1 and the third switching transistor Q3 separately receive the first control signal, for example, V_GATE1 and V_GATE3; and control ends of the second switching transistor Q2 and the fourth switching transistor Q4 separately receive the second control signal, for example, V_GATE2 and V_GATE4. A person skilled in the art should know that the coupling in this embodiment of the present disclosure includes a direct connection manner, an indirect connection manner, and the like.

The main circuit 11 is configured to perform, under control of the control signal, conductivity switching on the full-bridge circuit 112, and thereby control charging or discharging of the inductor 111 and charging or discharging of the capacitor 113 to generate the second current IF.

Herein, a process about how the main circuit 11 controls conductivity switching on the full-bridge circuit 112, and thereby controls the charging or discharging of the inductor 111 and charging or discharging of the capacitor 113, is described in brief. (1) When the switching transistors Q1 and Q3 are turned on simultaneously, the inductor 111 is discharged, and the second current IF is reduced. At the same time, the capacitor 113 is also discharged, and a voltage (which may also become an output voltage of the main circuit 11, and is marked with VC herein) of the capacitor 113 is also reduced. According to a principle of the full-bridge circuit, because phases of control signals of the switching transistors Q2 and Q4 are opposite to phases of control signals of the switching transistors Q1 and Q3, the switching transistors Q2 and Q4 are turned off simultaneously, which is not described in detail subsequently. For details, reference may be made to the prior art. (2) When the switching transistors Q2 and Q4 are turned on simultaneously, the process is just reverse to (1). In this case, the inductor 111 is charged, and the second current IF is increased. At the same time, the capacitor 113 is also charged, and the output voltage VC is increased.

It can be seen that, the main circuit 11 may adjust values of the second current IF and the output voltage VC by switching conductivity statuses of the switching transistors (Q1 and Q3) and the switching transistors (Q2 and Q4).

In this implementation manner, because the main circuit 11 uses an implementation manner of full-bridge inversion, a voltage stress and a loss borne by the main circuit 11 may be reduced. Therefore, the active filter using the main circuit 11 may be used in a scenario of a relatively high voltage.

In another implementation manner of this embodiment, the specific circuit structure of the main circuit 11 may be further shown in FIG. 4. In FIG. 4, the main circuit 11 includes an inductor 111, a capacitor 113, a fifth switching transistor Q5, and a sixth switching transistor Q6, where the sixth switching transistor Q6 is connected in parallel with a series circuit including the capacitor 113 and the fifth switching transistor Q5. One end of the sixth switching transistor Q6 is coupled to one end of the inductor 111, and another end of the sixth switching transistor Q6 is separately coupled to the negative electrode of the power source 4 and the negative electrode of the input end of the conversion circuit 2, that is, as shown in FIG. 2, jointly coupled to a node “d”. The other end of the inductor 111 is separately coupled to the positive electrode of the power source 4 and the positive electrode of the input end of the conversion circuit 2, that is, as shown in FIG. 2, jointly coupled to the node “c”. Similarly, herein, the inductor 111 may be a filter inductor, and the capacitor 113 may include an energy storage capacitor or a group of energy storage capacitors. The control signal generated by the control circuit 12 may also include a first control signal and a second control signal, where the second control signal is a signal having a phase opposite to a phase of the first control signal. In this case, the control end of the fifth switching transistor Q5 receives the first control signal, for example, V_GATE1, and the control end of the sixth switching transistor Q6 receives the second control signal, for example, V_GATE2.

The main circuit 11 is configured to perform, under the control of the control signal, conductivity switching on the fifth switching transistor Q5 and the sixth switching transistor Q6, and thereby control charging or discharging of the inductor 111 and charging or discharging of the capacitor 113 to generate the second current IF.

A process in which the main circuit 11 performs conductivity switching on the fifth switching transistor Q5 and the sixth switching transistor Q6 and thereby controls charging or discharging of the inductor 111 and charging or discharging of the capacitor 113 is as follows:

When the fifth switching transistor Q5 is turned on, the inductor 111 is discharged, the second current IF is reduced, the capacitor 113 is also discharged, and the voltage VC of the capacitor 113 is reduced.

When the sixth switching transistor Q6 is turned on, the inductor 111 is charged, the second current IF is increased, and the voltage VC of the capacitor 113 is increased.

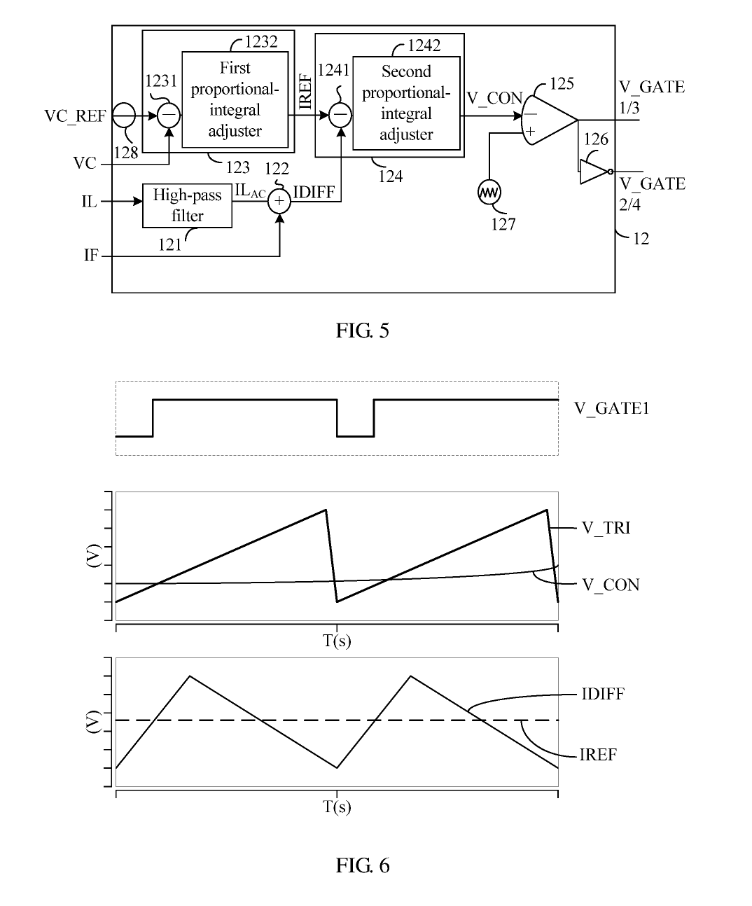

Further, herein, with reference to FIG. 3 and FIG. 4, a specific structure of the control circuit 12 in this embodiment of the present disclosure is described. In an implementation manner of this embodiment of the present disclosure, as shown in FIG. 5, the control circuit 12 includes a high-pass filter 121, an adder 122, a first proportional-integral controller 123, a second proportional-integral controller 124, a voltage comparator 125, and a phase inverter 126. The control circuit 12 may be configured to control the main circuit 11 shown in FIG. 3, and may also be configured to control the main circuit 11 shown in FIG. 4.

The high-pass filter 121 is configured to receive the first current IL, and perform filtering to obtain the harmonic component IL_{AC}. Using the high-pass filter 121 to perform high-pass filtering is to remove some low-frequency components that are unnecessary or insignificant, to obtain a high-frequency component that can reflect a present current fluctuation in the communications system, where a filter parameter may be determined according to an empirical value or through simulation calculation, or the like, which is not limited herein. For details, reference may be made to the prior art.

The adder 122 is configured to respectively receive the harmonic component IL_{Ac} and the second current IF through two output ends, and perform addition to obtain a third current IDIFF and output the third current.

The first proportional-integral controller 123 is configured to, separately receive a preset first reference voltage VC_REF and the output voltage VC that is of the main circuit 11, that is, the voltage VC between two ends of the capacitor 113, and after subtracting the output voltage VC from the first reference voltage VC_REF, perform first proportional integration to obtain a fourth current IREF. A person skilled in the art should know that the first reference voltage VC_REF may be set according to an empirical value or determined by means of simulation, test, or the like. The first proportional-integral controller 123 may be further referred to as a voltage loop proportional-integral controller, and may be further divided into a first subtractor 1231 and a first proportional-integral adjuster 1232, where two input ends of the first subtractor 1231 are used to respectively receive the first reference voltage VC_REF and the output voltage VC. After the subtraction operation is performed, the first proportional-integral adjuster 1232 performs first proportional integration on a difference obtained after the output voltage VC is subtracted from the first reference voltage VC_REF, to obtain the fourth current IREF and output the fourth current, which is not further described in detail herein. For details, reference may be made to the prior art. With respect to a gain (including an integral gain and a proportional gain) of the first proportional-integral controller 123, different gain functions may be preset for different application scenarios. A person skilled in the art should know that a principle of setting a gain function is generally that the higher a gain is, the better it will be, which is not further limited herein, provided that a stable current loop of the communications system is ensured.

The second proportional-integral controller 124 is configured to separately receive the third current IDIFF and the fourth current IREF, and after subtracting the third current IDIFF from the fourth current IREF, perform second proportional integration to obtain a first comparative voltage V_CON. Likewise, the second proportional-integral controller 124 may be referred to as a current loop proportional-integral controller, and may also be further divided into a second subtractor 1241 and a second proportional-integral adjuster 1242. With respect to a gain of the first proportional-integral controller 123, different gain functions may also be preset for different application scenarios.

The voltage comparator 125 receives the first comparative voltage V_CON through an inverting input end, and receives a preset second reference voltage V_TRI through a non-inverting input end, and is configured to compare the first comparative voltage V_CON with the second reference voltage V_TRI, generate the first control signal according to a comparison result, and separately provide the first control signal to the first switching transistor Q1 and the third switching transistor Q3 that are shown in FIG. 3 to control conductivity of the first switching transistor Q1 and the third switching transistor Q3, or provide the first control signal to the fifth switching transistor Q5 shown in FIG. 4 to control conductivity of the fifth switching transistor Q5. It should be known that a principle of the voltage comparator 125 is when a voltage of the non-inverting input end is higher than a voltage of the inverting input end, a high-level signal is output; when a voltage of the non-inverting input end is lower than a voltage of the inverting input end, a low-level signal is output. In this embodiment, optionally, the voltage comparator 125 may further receive the first comparative voltage V_CON through the non-inverting input end, and receive the preset second reference voltage V_TRI through the inverting input end, but logic in comparison is opposite, which is not limited in this embodiment.

The phase inverter 126 is configured to invert the phase of the first control signal to generate the second control signal, and separately provide the second control signal to the second switching transistor Q2 and the fourth switching transistor Q4 that are shown in FIG. 3 to control conductivity of the second switching transistor Q2 and the fourth switching transistor Q4, or provide the second control signal to the sixth switching transistor Q6 shown in FIG. 4 to control conductivity of the sixth switching transistor Q6.

Optionally, the control circuit 12 may further include a reference voltage source 128 configured to provide the first reference voltage VC_REF.

Optionally, the control circuit 12 may further include a signal generator 127 configured to provide the second reference voltage V_TRI. Exemplarily, the signal generator 127 may be a triangular wave generator, or a signal generator of another wave form.

Furthermore, the second reference voltage V_TRI may be a periodic triangular wave signal, and therefore, in any period of the triangular wave signal, that the voltage comparator 125 generates the first control signal according to the comparison result includes, if the first comparative voltage V_CON is higher than a level of the triangular wave signal V_TRI, generating the first control signal for turning off the first switching transistor Q1 and the third switching transistor Q3 or turning off the fifth switching transistor Q5; or if the first comparative voltage V_CON is lower than a level of the triangular wave signal V_TRI, generating the control signal for turning on the first switching transistor Q1 and the third switching transistor Q3 or turning on the fifth switching transistor Q5.

It should be noted that in this embodiment, a bandwidth of the second proportional-integral adjuster 124 is far greater than a bandwidth of the first proportional-integral controller 123, which ensures that within several open-loop periods, the fourth current IREF output by the first proportional-integral controller 123 may be a constant value. However, if the voltage VC of the capacitor 113 changes within a long time, for example, if the voltage VC is reduced, the fourth current IREF is caused to rise by using the second proportional-integral controller, and at the same time, the first comparative voltage V_CON is also caused to rise. If the voltage comparator 125 determines that the first comparative voltage V_CON is higher than the preset triangular wave signal V_TRI, the voltage comparator 125 generates the first control signal for turning off the first switching transistor Q1 and the third switching transistor Q3 or turning off the fifth switching transistor Q5. At the same time, the phase inverter 126 generates the second control signal for turning on the second switching transistor Q2 and the fourth switching transistor Q4, or turning on the sixth switching transistor Q6, so that the inductor 111 in the main circuit 11 is charged, and the capacitor 113 is also charged. Correspondingly, the voltage VC of the capacitor 113 is also increased, so that the fourth current IREF output by the first proportional-integral controller 123 and the voltage VC of the capacitor 113 keep constant.

The following further describes a principle of generating the first control signal with reference to FIG. 6 by using an example in which the first switching transistor Q1 and the third switching transistor Q3 are NMOS transistors, or the fifth switching transistor Q5 is an NMOS transistor, and the voltage comparator 125 receives the first comparative voltage V_CON through the inverting input end, and receives the preset second reference voltage V TRI through the non-inverting input end.

First, it should be noted that conductivity characteristics of the NMOS transistor include, when a voltage of a gate is of a high level, a source and a drain of the NMOS transistor are connected. When the voltage of the gate is of a low level, the source and the drain of the NMOS transistor are disconnected. Contrary to the NMOS transistor, for a switching transistor of another type, for example, a PMOS transistor, when a voltage of a gate of the PMOS transistor is of a high level, a source and a drain of the PMOS transistor are disconnected and when a voltage of the gate of the PMOS transistor is of a low level, the source and the drain of the PMOS transistor are connected. In this case, the voltage comparator 125 needs to receive the first comparative voltage V_CON through the non-inverting input end, and receive the second reference voltage V TRI through the inverting input end. A person skilled in the art may perform extension based on this. Therefore, the switching transistor in this embodiment of the present disclosure is not limited to the PMOS transistor or the NOMS transistor.

In an actual circuit, elements in the main circuit 11 may generate some energy losses inevitably. It is necessary to compensate for this part of energy losses, or otherwise, the voltage VC of the capacitor 113 in the main circuit 11 may fall. Once the voltage VC falls and is lower than an upper limit of a bus voltage, a current of the inductor 111 in the main circuit 11 cannot be discharged, and consequently, the main circuit 11 cannot have a filter effect. Therefore, to maintain the voltage VC of the capacitor 113, theoretically, the harmonic component IL_{AC} of the first current IL and the second current IF need to meet a relationship shown in a formula (5):

IF+IL_{AC}=IREF (5)

where, IREF is the fourth current.

Therefore, in order that the active filter 1 can suppress low-frequency noise caused by the load 3, the control circuit 12 needs to use, in a control process, the principle shown in the formula (5) to perform control, and furthermore, needs to acquire the sum of the second current IF and the harmonic component IL_{AC} in real time, that is, the third current IDIFF, then use the fourth current IREF as a reference value, so that the third current IDIFF traces the fourth current IREF in real time. Because it may be considered that the first comparative voltage V_CON is quasi-proportional to a difference between the third current IDIFF and the fourth current IREF, a process of generating the first control signal by the voltage comparator 125 is as follows:

When the first comparative voltage V_CON is higher than the level of the triangular wave signal V TRI, it indicates that the real-time third current IDIFF is less than the fourth current IREF. Therefore, the second current IF needs to be increased, so that the real-time third current IDIFF is approximate to the fourth current IREF, that is, the inductor 111 and/or the capacitor 113 in the main circuit 11 needs to be controlled to be in a charged state to increase the real-time second current IF. Therefore, the voltage comparator 125 may generate a first control signal of a low level, so that the NMOS transistor is turned off.

When the first comparative voltage V_CON is lower than the level of the triangular wave signal V_TRI, it indicates that the real-time third current IDIFF is greater than the fourth current IREF. Therefore, the second current IF needs to be reduced, that is, the inductor 111 and/or the capacitor 113 in the main circuit 11 needs to be controlled to be in a discharged state to reduce the real-time second current IF. Therefore, the voltage comparator 125 may generate a first control signal of a high level, so that the NMOS transistor is turned on. This control manner is a pulse-width modulation (PWM) manner, and is applicable to a scenario in which a requirement on a filter indicator is relatively low.

Because the second control signal for controlling the second switching transistor Q2 and the fourth switching transistor Q4 in FIG. 3 or the sixth switching transistor Q6 in FIG. 4 is a signal having a phase opposite to the phase of the first control signal. Their control logic is just opposite, and details are not described herein again.

It should be known that, in the foregoing process of generating the first control signal, the NMOS transistor is used as an example. If both the first switching transistor Q1 and the third switching transistor Q3 in FIG. 3 are PMOS transistors, or the fifth switching transistor Q5 in FIG. 4 is a PMOS transistor, the non-inverting input end of the voltage comparator 125 needs to be used to receive the first comparative voltage V_CON, and the inverting input end needs to be used to receive the second reference voltage V_TRI, so that the levels of the generated first control signal are just opposite.

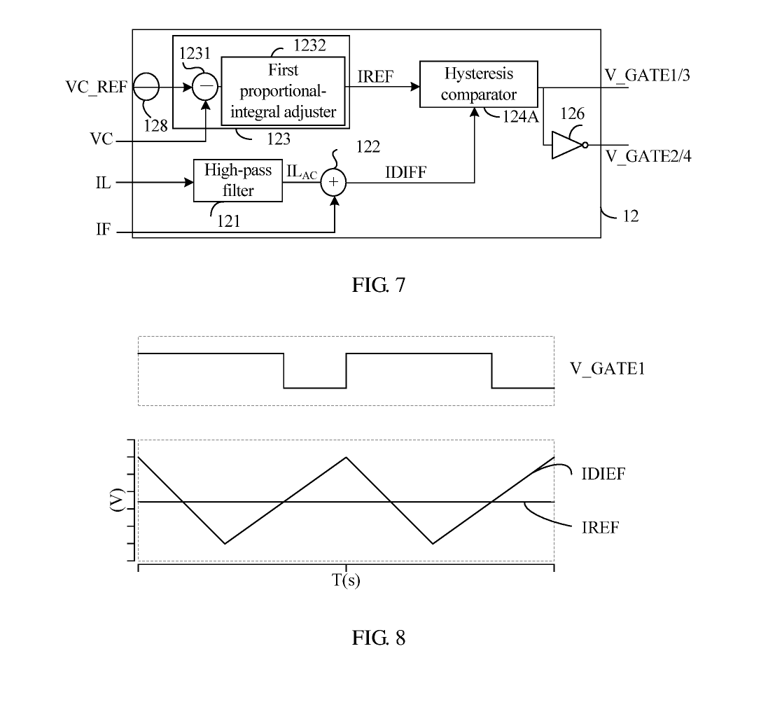

Further, in another implementation manner of this embodiment of the present disclosure, as shown in FIG. 7, a control circuit 12 is further provided. Herein, a specific structure of the control circuit 12 shown in FIG. 7 is described still with reference to FIG. 3 and FIG. 4. The control circuit 12 may be configured to control the main circuit 11 shown in FIG. 3, and may also be configured to control the main circuit 11 shown in FIG. 4. The control circuit 12 includes a high-pass filter 121, an adder 122, a first proportional-integral controller 123, a hysteresis comparator 124A, and a phase inverter 126. For ease of description, elements that are the same as those in the control circuit 12 shown in FIG. 5 are marked with same numbers herein. For details, reference may be made to the description about the elements in the foregoing implementation manners.

The high-pass filter 121 is configured to receive the first current IL, and perform filtering to obtain the harmonic component IL_{AC}.

The adder 122 is configured to separately receive the harmonic component IL_{AC} and the second current IF, and perform addition to obtain a third current IDIFF.

The first proportional-integral controller 123 is configured to separately receive a preset first reference voltage VC_REF and an output voltage VC of the main circuit 11, and after subtracting the output voltage VC from the first reference voltage VC_REF, perform first proportional integration to obtain a fourth current IREF.

The hysteresis comparator 124A is configured to compare the third current IDIFF with the fourth current IREF, and generate the first control signal according to a comparison result, and separately provide the first control signal to the first switching transistor Q1 and the third switching transistor Q3 in FIG. 3, to control conductivity of the first switching transistor Q1 and the third switching transistor Q3 in FIG. 3, or provide the first control signal to the fifth switching transistor Q5 in FIG. 4, to control conductivity of the fifth switching transistor Q5 in FIG. 4. It should be noted that, by using the hysteresis comparison control manner, the control circuit traces the first circuit IL at a higher speed, which is advantageous for improving filter performance, and is applicable to a scenario in which a filter requirement is high and a cost requirement is low.

The phase inverter 126 is configured to invert the phase of the first control signal to generate the second control signal, and separately provide the second control signal to the second switching transistor Q2 and the fourth switching transistor Q4 in FIG. 3, to control conductivity of the second switching transistor Q2 and the fourth switching transistor Q4 in FIG. 3, or provide the second control signal to the sixth switching transistor Q6 in FIG. 4, to control conductivity of the sixth switching transistor Q6 in FIG. 4.

Optionally, the control circuit 12 may further include a reference voltage source 128 configured to provide the first reference voltage VC_REF.

Furthermore, that the hysteresis comparator 124A generates the first control signal according to the comparison result includes, if the third current IDIFF is greater than the fourth current IREF, generate the first control signal for turning on the first switching transistor Q1 and the third switching transistor Q3 in FIG. 3 or turning on the fifth switching transistor Q5 in FIG. 4, so that the inductor 111 and/or the capacitor 113 in the main circuit 11 is in a discharged state, and the real-time second current IF is reduced, or if the third current IDIFF is less than the fourth current IREF, generate the first control signal for turning off the first switching transistor Q1 and the third switching transistor Q3 in FIG. 3 or turning off the fifth switching transistor Q5 in FIG. 4, so that the inductor 111 and/or the capacitor 113 in the main circuit 11 is in a charged state, and the real-time second current IF is increased.

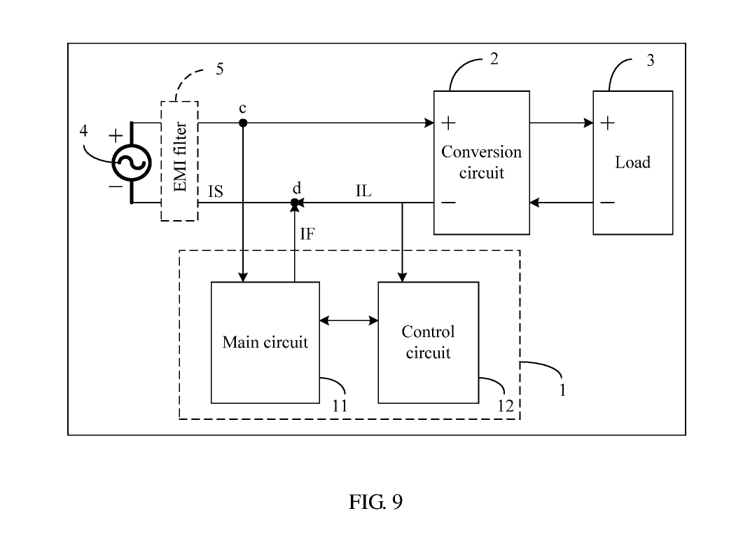

The following further describes a principle of generating the first control signal by the hysteresis comparator 124A with reference to FIG. 8 still by using an example in which the first switching transistor Q1 and the third switching transistor Q3 in FIG. 3 are NMOS transistors, or the fifth switching transistor Q5 in FIG. 4 is an NMOS transistor.

As described above, when the main circuit 11 suppresses low-frequency noise, the third current IDIFF needs to trace the fourth current IREF in real time. Therefore, the process of generating the first control signal by the hysteresis comparator 124A is as follows:

When the third current IDIFF is greater than the sum of the fourth current IREF and a preset hysteresis value hys, that is, the following formula is met:

IDIFF>IREF+hys (6)

to trace the fourth current IREF, it is necessary to reduce the second current IF, so that the real-time third current IDIFF is approximate to the fourth current IREF, that is, the inductor 111 and/or the capacitor 113 in the main circuit 11 needs to be controlled to be in a discharged state to reduce the real-time second current IF. Therefore, the hysteresis comparator 124A may generate a first control signal of a high level, where the hysteresis value hys is generally set to a small value. For the specific setting of the hysteresis value hys and the principle of hysteresis comparison, reference may be made to the prior art.

When the third current IDIFF is less than a difference between the fourth current IREF and the hysteresis value hys, that is:

IDIFF<IREF−hys (7)

It may be necessary to increase the second current IF, so that the real-time third current IDIFF is approximate to the fourth current IREF, that is, the inductor 111 and/or the capacitor 113 in the main circuit 11 needs to be controlled to be in a charged state to increase the real-time second current IF. Therefore, the hysteresis comparator 124A may generate a first control signal of a low level.

In this embodiment of the present disclosure, because the second control signal for controlling the second switching transistor Q2 and the fourth switching transistor Q4 in FIG. 3 or the sixth switching transistor Q6 in FIG. 4 is a signal having a phase opposite to a phase of the first control signal. Their control logic is just opposite, and details are not described herein again.

Further, optionally, the communications system using the active filter as shown in FIG. 9 may further include an electromagnetic interference filter 5. For other elements, reference may be made to FIG. 2.

The electromagnetic interference filter 5 is connected in parallel between the power source 4 and the active filter 1, and configured to suppress high-frequency interference in the communications system.

In this embodiment, a control circuit 12 generates a control signal to control a main circuit 11 to generate a second current IF having a phase opposite to a phase of a harmonic component IL_{AC}, so as to cancel the harmonic component IL_{AC} and effectively suppress low-frequency noise caused by a non-linear load 3. Therefore, a disadvantage that a volume of a filter is huge, which cannot meet a filter requirement of a high-power device, and the like in the prior art are avoided, and it is ensured that an input current is approximate to a direct current. In addition, compared with a passive filter used by a communications device in the prior art, the active filter provided in this embodiment may reduce a cost of the communications system significantly, and on the other hand, may meet a filter requirement for miniaturization of the high-power communications system because the volume of the active filter is small.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. An active filter, wherein the active filter is connected in parallel between a power source and an input end of a conversion circuit, wherein an input end of the active filter is separately coupled to a positive electrode of the power source and a positive electrode of the input end of the conversion circuit, wherein an output end of the active filter is separately coupled to a negative electrode of the power source and a negative electrode of the input end of the conversion circuit, and wherein the active filter comprises:
a control circuit; and
a main circuit,
wherein the control circuit is configured to:
detect a first current output by the negative electrode of the input end of the conversion circuit;
acquire an alternating current component (harmonic component) in the first current; and
generate a control signal according to the harmonic component, wherein the main circuit is configured to:
generate under the control of the control signal, a second current having a phase opposite to a phase of the harmonic component; and
output the second current through the output end of the active filter, so that a source current formed after the first current and the second current pass through the power source is a direct current.

2. The active filter according to claim 1, wherein the control signal comprises:
a first control signal; and
a second control signal,
wherein the second control signal is a signal having a phase opposite to a phase of the first control signal,
wherein the main circuit comprises:
a full-bridge circuit;
an inductor; and
a capacitor,
wherein the full-bridge circuit comprises:
a first switching transistor;
a second switching transistor;
a third switching transistor; and
a fourth switching transistor,
wherein a series circuit comprising the first switching transistor and the fourth switching transistor is separately connected in parallel with the capacitor and a series circuit comprising the second switching transistor and the third switching transistor,
wherein one end of the inductor is coupled to a node between the first switching transistor and the fourth switching transistor,
wherein another end of the inductor is used as the input end of the active filter,
wherein a node between the second switching transistor and the third switching transistor is used as the output end of the active filter,
wherein control ends of the first switching transistor and the third switching transistor separately receive the first control signal,
wherein the control ends of the second switching transistor and the fourth switching transistor separately receive the second control signal, and
wherein the main circuit is further configured to perform, under the control of the control signal, conductivity switching on the full-bridge circuit, and thereby control charging or discharging of the inductor and charging or discharging of the capacitor to generate the second current.

3. The active filter according to claim 1, wherein the control signal further comprises
a first control signal; and
a second control signal, wherein the second control signal is a signal having a phase opposite to a phase of the first control signal,
wherein the main circuit comprises:
an inductor;
a capacitor;
a fifth switching transistor; and
a sixth switching transistor,
wherein the sixth switching transistor is connected in parallel with a series circuit comprising the capacitor and the fifth switching transistor,
wherein one end of the sixth switching transistor is coupled to one end of the inductor,
wherein another end of the sixth switching transistor is used as the output end of the active filter,
wherein another end of the inductor is used as the input end of the active filter,
wherein a control end of the fifth switching transistor receives the first control signal,
wherein a control end of the sixth switching transistor receives the second control signal,
wherein the main circuit is further configured to perform, under control of the control signal, conductivity switching on the fifth switching transistor and the sixth switching transistor, and thereby control charging or discharging of the inductor and charging or discharging of the capacitor to generate the second current.

4. The active filter according to claim 2, wherein the control circuit comprises:
a high-pass filter;
an adder;
a first proportional-integral controller;
a second proportional-integral controller;
a voltage comparator; and
a phase inverter,
wherein the high-pass filter is configured to:
receive the first current; and
perform filtering to obtain the harmonic component,
wherein the adder is configured to:
separately receive the harmonic component and the second current; and
perform addition to obtain a third current;
wherein the first proportional-integral controller is configured to:
separately receive a preset first reference voltage and an output voltage that is of the main circuit; and
perform first proportional integration to obtain a fourth current after subtracting the output voltage from the first reference voltage,
wherein the output voltage of the main circuit is a voltage between two ends of the capacitor;
wherein the second proportional-integral controller is configured to:
separately receive the third current and the fourth current, and after subtracting the third current from the fourth current,
perform second proportional integration to obtain a first comparative voltage;
wherein the voltage comparator is configured to:
compare the first comparative voltage with a preset second reference voltage;
generate the first control signal according to a comparison result; and
input the first control signal to the main circuit and the phase inverter, and
wherein the phase inverter is configured to:
invert the phase of the first control signal to obtain the second control signal, and
input the second control signal to the main circuit.

5. The active filter according to claim 4, wherein the second reference voltage is a periodic triangular wave signal, and therefore, in any period, the voltage comparator is further configured to:
generate the first control signal for turning off the first switching transistor and the third switching transistor or turning off the fifth switching transistor when the first comparative voltage is higher than a level of the triangular wave signal; and
generate the first control signal for turning on the first switching transistor and the third switching transistor or turning on the fifth switching transistor when the first comparative voltage is lower than a level of the triangular wave signal.

6. The active filter according to claim 2, wherein the control circuit comprises:
a high-pass filter;
an adder;
a first proportional-integral controller;
a hysteresis comparator; and
a phase inverter;
wherein the high-pass filter is configured to:
receive the first current; and
perform filtering to obtain the harmonic component,
wherein the adder is configured to:
separately receive the harmonic component and the second current; and
perform addition to obtain a third current, wherein the first proportional-integral controller is configured to:
separately receive a first reference voltage and an output voltage that is of the main circuit; and
perform first proportional integration to obtain a fourth current after subtracting the output voltage from the first reference voltage,
wherein the output voltage of the main circuit is a voltage between two ends of the capacitor,
wherein the hysteresis comparator is configured to:
compare the third current with the fourth current; and
generate the first control signal according to a comparison result, and
wherein the phase inverter is configured to invert the phase of the first control signal to obtain the second control signal.

7. The active filter according to claim 6, wherein the hysteresis comparator is further configured to:
generate the first control signal for turning on the first switching transistor and the third switching transistor or turning on the fifth switching transistor when the third current is greater than the fourth current; and
generate the first control signal for turning off the first switching transistor and the third switching transistor or turning off the fifth switching transistor when the third current is less than the fourth current.

8. The active filter according to claim 2, wherein the inductor is a filter inductor, and wherein the capacitor is an energy storage capacitor or a group of energy storage capacitors.

9. A communications system, wherein the communications system comprises:
a power source;
a conversion circuit;
a non-linear load; and
an active filter,
wherein the active filter is connected in parallel between the power source and an input end of the conversion circuit,
wherein an input end of the active filter is separately coupled to a positive electrode of the power source and a positive electrode of the input end of the conversion circuit,
wherein an output end of the active filter is separately coupled to a negative electrode of the power source and a negative electrode of the input end of the conversion circuit, and
wherein the active filter comprises:
a control circuit; and
a main circuit,
wherein the control circuit is configured to:
detect a first current output by the negative electrode of the input end of the conversion circuit;
acquire an alternating current component (harmonic component) in the first current; and
generate a control signal according to the harmonic component,
wherein the main circuit is configured to:
generate under the control of the control signal, a second current having a phase opposite to a phase of the harmonic component; and
output the second current through the output end of the active filter, so that a source current formed after the first current and the second current pass through the power source is a direct current,
wherein the power source is configured to output a source current, and
wherein the conversion circuit is configured to:
receive the source current through an input end; and
output a converted current to the non-linear load through an output end to supply power to the non-linear load after performing direct current/direct current conversion.

10. The communications system according to claim 9, wherein the communications system further comprises an electromagnetic interference filter, wherein the electromagnetic interference filter is connected in parallel between the power source and the active filter, and configured to suppress high-frequency interference in the communications system.
